(19) United States
(12) Patent Application Publication
(10) Pub. No.: US 2006/0192858 A1
(43) Pub. Date: Aug. 31, 2006

(54) Oil damping for camera optical assembly

(76) Inventor: Robert J. Calvet, Pasadena, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/219,137

(22) Filed: Sep. 1, 2005

Related U.S. Application Data
(60) Provisional application No. 60/657,261, filed on Feb. 28, 2005.

(51) Int. Cl. H04N 5/228

(52) U.S. Cl. 348/208.7

(57) ABSTRACT

A method and system for damping movement of a stage, such as a stage to which camera optics are attached, is disclosed. A viscous substance, such as silicone oil, can be disposed between the stage and a snubber assembly so as to substantially mitigate ringing of the stage as it is moved from one position to another. The viscous substance also mitigates damage due to vibration and shock.

### CROSS-REFERENCE TO RELATED APPLICATIONS

This patent application claims the benefit of the priority date of U.S. provisional patent application Ser. No. 60/657,261, filed Feb. 28, 2005 and entitled AUTOFOCUS CAMERA (docket No. M-15826-V1 US) pursuant to 35 USC 119. The entire contents of this provisional patent application are hereby expressed incorporated by reference.

### TECHNICAL FIELD

The present invention relates generally to cameras. The present invention relates more particularly to a method and system for oil damping of a stage and snubber assembly to better control the motion of optical elements in a miniature camera, such as a miniature camera that is suitable for use in a cellular telephone.

### BACKGROUND

Miniature cameras are well known. Miniature cameras are widely used in contemporary cellular telephones. They are also used in other devices, such as laptop computers and personal digital assistants (PDAs). Miniature cameras can even be used as stand alone devices for such applications as security and surveillance.

Contemporary miniature cameras, such as those used in cellular telephones, are fixed focus cameras. That is, the focus of the cameras is preset. The camera has a small enough aperture so as to provide sufficient depth of field such that focus is generally acceptable over a wide range of distances. However, such stopping down of the camera severely limits it's use in low light conditions.

Variable focus necessitates the use of movable optics. However, movable optics suffer from inherent disadvantages. For example, intentional movement of the optics can result in additional, undesirable movement thereof, referred to herein a ringing. Ringing results from the natural tendency of a moving structure to overshoot its final position, then oscillate about its final position, when moved thereto via an actuator or motor. Ringing is a consequence of the resonant frequency of the moved structure and its inherent tendency to oscillate at this frequency. Ringing can interfere with the use of such features as autofocus and zoom.

Further, undesirable movement of the optics, such as due to shock or vibration, can result in damage to the camera. As such, it is desirable to provide a way to dampen such undesirable movement and thereby mitigate the likelihood of such damage. Thus, it is desirable to limit the movement of optics in a variable focus camera so as to mitigate ringing and to reduce the adverse affects of shock and vibration.

### BRIEF SUMMARY

A method and system for damping the movement of a structure, such the optics of a camera, are disclosed. For example, the present invention can be used to dampen movement of the focusing and/or zooming optics of a camera, such as a miniature camera suitable for use in cellular telephones.

According to one embodiment of the present invention, a viscous substance such a silicone oil is disposed intermediate a stage upon which optics can be attached and a snubber assembly that limits motion of the stage to that motion which is appropriate for functioning of the optics. The viscous substance can be an oil, such as a silicone oil.

According to one aspect of the present invention, a reservoir is defined, such as by cooperation of the stage assembly and the snubber assembly. The reservoir contains a portion of the viscous substance and provides the viscous substance to an interface of the stage and the snubbers where the viscous substance dampens movement of the stage to mitigate undesirable ringing and to protect against shock and vibration.

This invention will be more fully understood in conjunction with the following detailed description taken together with the following drawings.

### BRIEF DESCRIPTION OF THE DRAWINGS

FIG. 1 is perspective top view of a stage and snubber assembly according to an exemplary embodiment of the present invention;

FIG. 2 is a top perspective cross-sectional view of the stage and snubber assembly taken along line 2 of FIG. 1;

FIG. 3 is an outboard perspective view of a snubber portion of FIG. 1;

FIG. 4 is an inboard perspective view of the snubber portion of FIG. 3;

FIG. 5 is a top or bottom (both are identical) perspective view of the stage assembly of FIG. 1;

FIG. 6 is an enlarged fragmentary view of the interface of the top snubber, the bottom snubber, and the stage, taken within line 5 of FIG. 2;

FIG. 7 is the inboard perspective view of the snubber portion as shown in FIG. 3, with stippling added to show where oil is disposed so as to effect damping;

FIG. 8 is an enlarged fragmentary view of the interface of the top snubber, the bottom snubber, and the stage, as shown in FIG. 6, with stippling added to show where oil is disposed so as to effect damping;

FIG. 9 is a graph showing the nominal electrical drive signal for effecting an incremental movement of the stage, which is also indicative of the ideal motion of the stage;

FIG. 10 is a graph showing exemplary movement of a stage without the use of damping, wherein excessive ringing is present;

FIG. 11 is a graph showing exemplary movement of a stage with the use of damping, wherein less than critical damping occurs and ringing is substantially mitigated;

FIG. 12 is a graph showing exemplary movement of a stage with the use of damping, where critical damping occurs and no ringing is present; and

FIG. 13 is a back view of a cellular telephone having a miniature camera according to one embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

A method and system for reducing undesirable motion of a stage is disclosed. By reducing this motion, ringing is mitigated and the adverse affects of shock and vibration are reduced. Thus, movement of camera optics, for example, is made more regular and predictable, resulting in higher quality images and more reliable operation.

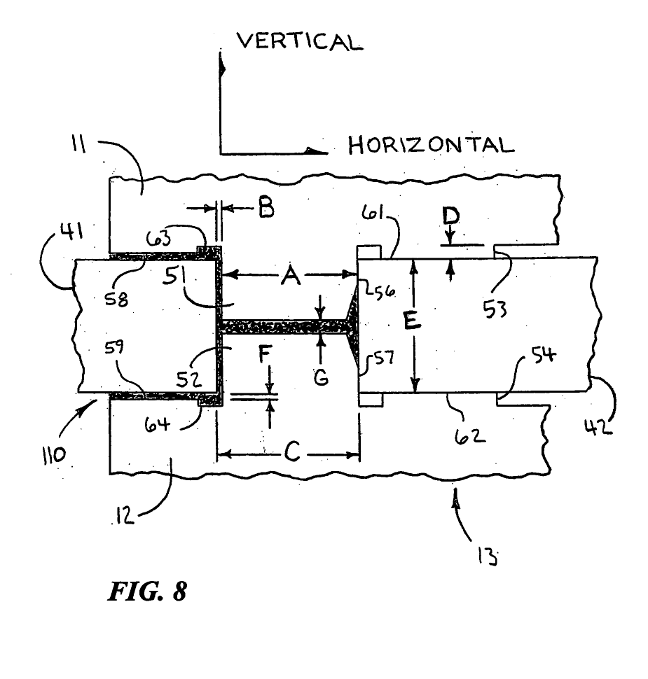

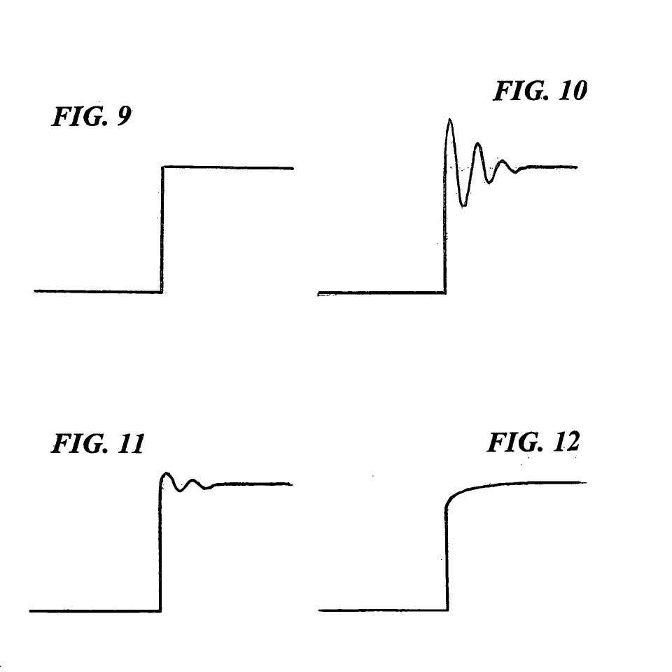

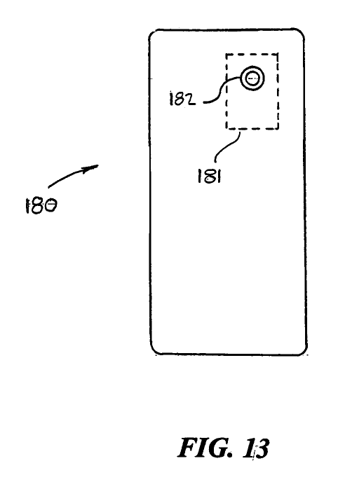

Ringing, as discussed in further detail below with reference to FIGS. 9-12, is the undesirable oscillation or vibration of a structure, such as a stage and the optics mounted thereon, that occurs after the structure has been moved rapidly to a new position. Such rapid movement occurs when optics are moved for focusing and zooming. When the structure abruptly halts at the new position, it tends to oscillate about this position momentarily. This effect is referred to as ringing. Ringing tends to reduce the accuracy of focus or zooming and/or undesirably introduce the need for increased settling time.

Ringing is mitigated by damping the movement of a stage, such as a stage upon which camera optics are mounted. According to one embodiment of the present invention, damping is effected by providing a viscous substance, such as oil, between a fixed structure with respect to which the stage moves and the stage itself. Thus, the viscous substance inhibits undesirable movement of the stage, so as to mitigate ringing and so as to inhibit movement due to shock and vibration.

The stage is suitable for mounting camera optics upon. For example, focus and/or zoom lenses can be mounted to the stage. According to one aspect of the present invention, motion of the stage in six degrees of freedom is controlled. More particularly, motion in five degrees of freedom is substantially limited, while motion in one translation degree is freedom is facilitated.

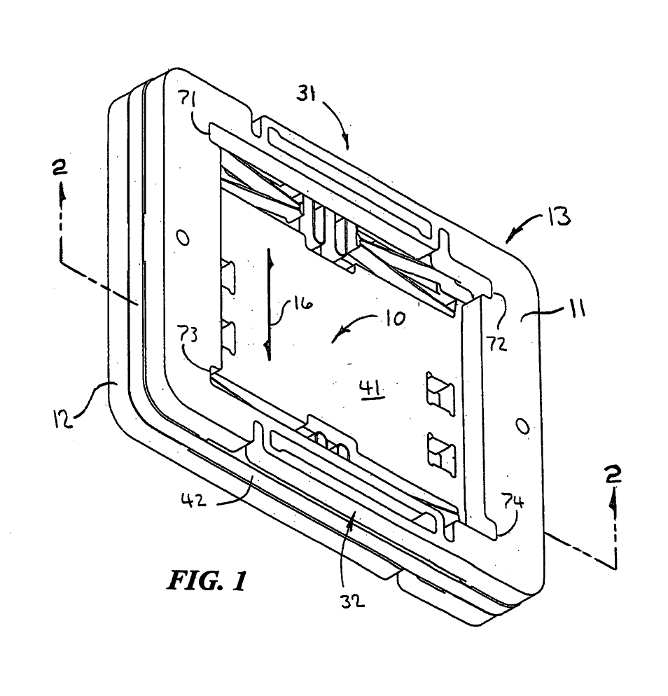

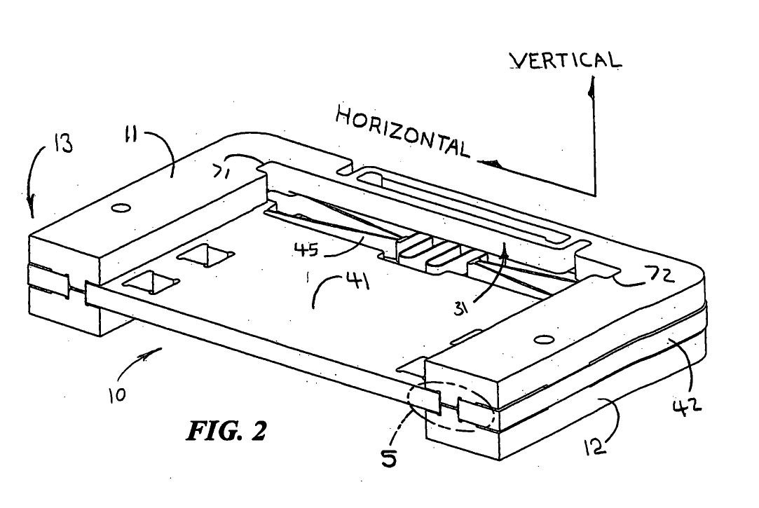

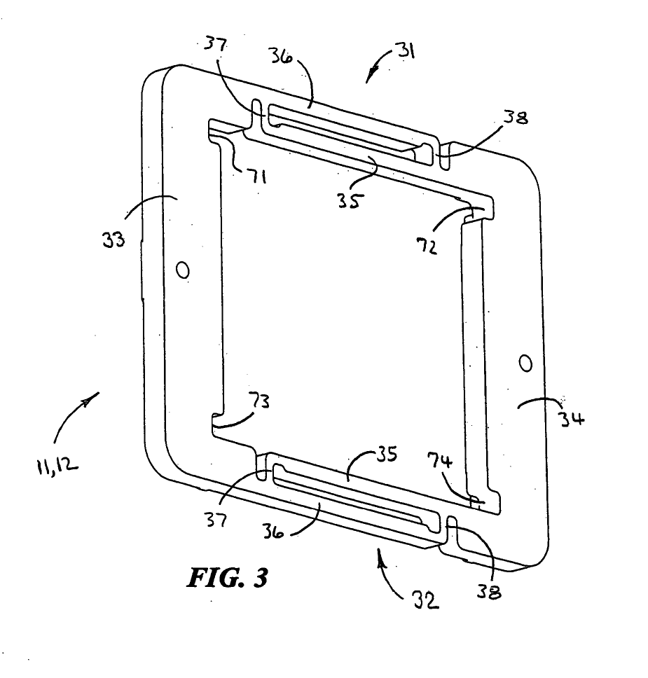

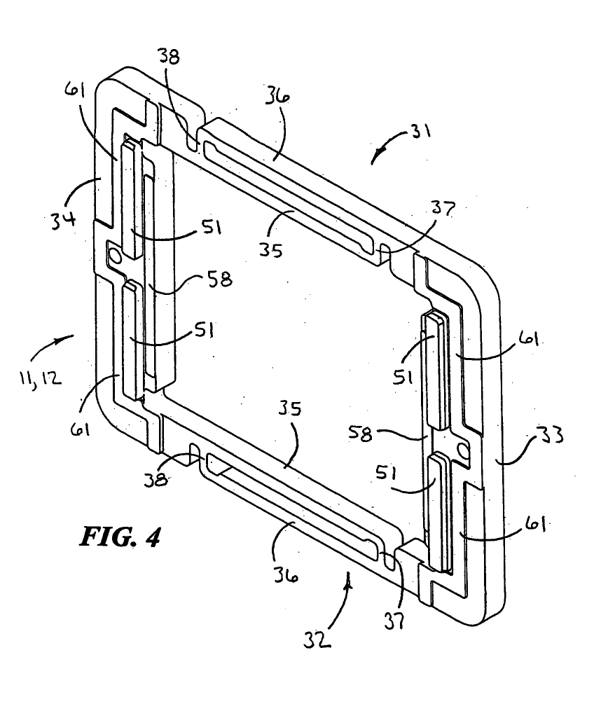

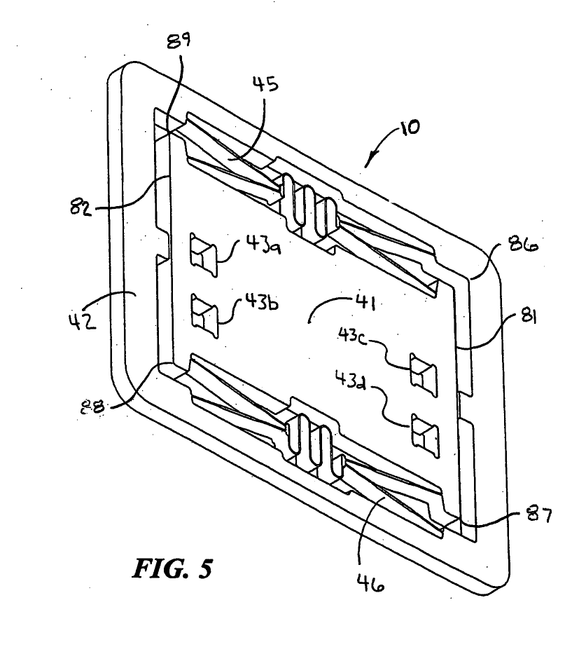

Referring now to FIGS. 1 and 2, a stage assembly 10 (better shown in FIG. 5) is sandwiched between two portions, 11 and 12 (better shown in FIGS. 3 and 4), of a snubber assembly 13, according to one embodiment of the present invention. The stage assembly 10 and the snubber assembly 13 can be generally planar structures, formed from silicon, for instance. Stage assembly 10 and/or snubber assembly 13 can alternatively be formed from another material, such as plastic or metal.

Stage assembly 10 comprises a stage 41 that moves back-and-forth, so as to facilitate movement of optics for focusing and/or zooming, for example. Stage assembly 10 further comprises a frame 42 that generally surrounds stage 41 (as best seen in FIG. 5). Frame 42 is fixed in position with respect to snubber assembly 13 and thus does not move. Arrow 16 shows the back-and-forth directions of motion of stage 41 with respect to frame 42 (better shown in FIG. 5) and with respect to snubber assembly 13. Snubber assembly 13 facilitates such back-and-forth motion of stage 41 while substantially inhibiting all other motions of stage 41.

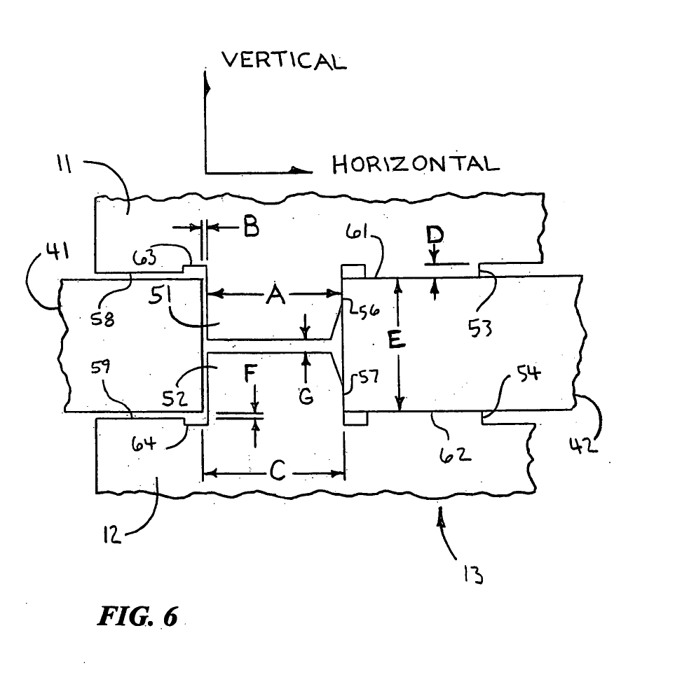

Referring now to FIGS. 3 and 4, each portion 11, 12 of snubber assembly 13 can be a generally planar and generally rectangular structure. Snubber assembly 13 can comprise two biasing members 31 and 32 that function as springs to bias two sides 33 and 34 outwardly, so as to cause them to contact portions (surfaces 56 and 57 as shown in FIG. 6) of frame 42 in a manner that advantageously positions critical features of snubber assembly 13, as discussed in detail below. Alternatively, the inherent resiliency of snubber assembly 13 can effect such biasing.

Each biasing member 31, 32 can comprise an inboard member 35, an outboard member 36, and two side members 37 and 38 that are configure to cooperate so as to provide spring tension that moves the sides 33 and 34 outwardly after sides 33, 34 have been pushed inwardly (such as when stage assembly 10 is being installed therebetween). That is, the rectangle defined by an inboard member 35, an outboard member 36, and two side members 37 and 38 can deform so as to define a parallelogram that provides spring tension. Each portion 11, 12 of snubber assembly 13 further comprises structural features that cooperate with stage assembly 10 to define tolerances or spacings between snubber assembly 13 and stage 41, as discussed in detail with reference to FIG. 6 below.

With particular reference to FIG. 4, each portion 11, 12 of snubber assembly 13 has formed upon an inboard (snubber assembly 10 contacting) surface thereof a plurality of mesas 51, shims 61, and stops 58, the functions of which are discussed in detail with reference to FIG. 6 below.

Referring now to FIG. 5, stage assembly 10 comprises a movable portion or stage 41 and a fixed portion or frame 42. Stage 41 can be a generally planar, generally rectangular structure. Optics are attachable, either directly or indirectly, to stage 41.

Stage 41 can move in response to a motor or actuator, such as to effect focusing and/or zooming. For example, an optics assembly (not shown) can be attached to stage 41 via apertures 43a-43d.

Frame 42 can similarly be a generally planar and generally rectangular structure that can substantially surround a periphery of stage 41. Frame 42 can be movably attached to stage 41 via flexure assemblies 45 and 46. Flexure assemblies 45 and 46 can preferentially facilitate movement of stage 41 in one desired translational degree of freedom, i.e., in the back-and-forth directions of arrow 16 of FIG. 1. Snubber assembly 13 can limit movement of stage 41 that is beyond the one desired translation degree of freedom.

Stage 41, as well as frame 42, snubber assembly 13, and other components of the present invention, can be of any desired shape and/or configuration. Stage assembly 10 can be formed monolithically, such as via the etching or milling of a single piece of silicon or other material. Similarly, snubber assembly 13 can also be formed monolithically. Alternatively, stage assembly 10 and/or snubber assembly 13 can be formed in any other desired manner using any desired material. Indeed, the reduced precision needed by snubber assembly 13 according to one aspect of the present invention allows snubber assembly 13 to be formed of plastic using low a precision manufacturing process.

Snubber assembly 13 defines limits to movement of stage 41, so as to inhibit movement in five other degrees of freedom for which it is desirable to restrict movement of stage 41. Such limitations on the movement of stage 41 tend to maintain desired alignment of components, such as optics. The limitations are also desirable, for example, in the event of shock or vibration that would other cause stage 41 to move in a manner that may cause damage to itself or other components, e.g., lenses of a camera. Thus, the stage, and consequently the camera optics, can be permitted to move in a manner that facilitates desired functionality, e.g., focusing and/or zooming, while also being restrained in a manner that mitigates undesirable malfunctioning (misalignment of optics) and damage.

Referring now to FIG. 6, exemplary structures of stage assembly 10 and snubber assembly 13 that limit motion of stage 41 in five degrees of freedom while facilitating substantially more motion in a sixth degree of freedom (as indicated by arrow 16 in FIG. 1) are shown. Each portion 11, 12 of snubber assembly 13 comprises features such as mesas 51, 52, shims 53, 54, and stops 58, 59 that define limits to the movement of stage 41 in five degrees of freedom while permitting unrestricted movement of stage 41 in one degreed of freedom.

Mesas 51, 52, shims 53, 54, and stops 58, 59 are formed precisely. They are also precisely positioned by keying to or abutting precisely formed portions of frame 42, so that they are, in-turn, precisely positioned themselves and are thus suitable for defining limits to the movement of stage 41.

In this manner, the limits to the movement of stage 41 can be defined with greater precision than the precision with which the overall snubber assembly 13 is manufactured because the snubber assembly 13 cooperates with the frame 42 of the stage assembly 10 to define positioning of the structures that limit motion of stage 41 and because frame 42 is manufactured with sufficient precision so as to facilitate such definition of these positions.

More particularly, the width, Dimension A, of each mesa 51, 52 together with the distance between stage 41 and frame 42, Dimension C, defines the size of the horizontal gap, Dimension B, between stage 41 and snubber assembly 13. Since the width of each mesa 51, 52, Dimension A, and the distance between the stage 41 and the frame 42, Dimension C, can be easily controlled, the horizontal gap, Dimension B, can likewise be easily controlled. The distance between the stage 41 and frame 42, Dimension C, is controlled by precisely manufacturing the overall dimensions of stage assembly 10. The width of mesa 51, 52 only requires precision in the manufacturing of a comparatively small portion of the snubber assembly 13, i.e., each mesa 51, 52 itself. It does not require that the position of each mesa 51, 52 be precisely determined during manufacturing of snubber assembly 13.

Positioning of each mesa 51, 52 is determined by its contact with fame 42 at surfaces 56 and 57. Contact at surfaces 56 and 57 is effected by the outward biasing of side members 33 and 34 of each portion 11, 12 of snubber assembly, as described above. Since frame 42 of snubber assembly 13 is manufactured with precision, this contact point is precisely located. Thus, the size of the horizontal gap, Dimension B, between the stage 41 and the snubber assembly 13 can be controlled without requiring that the overall manufacturing tolerances of snubber assembly 13 be precise.

Similarly, the thickness, Dimension D, of each shim 53, 54 together with the thickness, Dimension E, of frame 42, defines the size of each horizontal gap, such as Dimension F, between stage 41 and the stops 58, 59 of snubber assembly 13. Shims 53, 54 contact frame 42 at surfaces 61, 62 thereof. This contact is effected by attachment of the upper portion 11 to the lower portion 12 of snubber assembly 13 by any desired means, such as by adhesive bonding. There are two such vertical gaps on each of the two sides of stage 41. On each side of stage 41, one vertical gap is above stage 41 and one vertical gap is below stage 41. Since the thickness, Dimension D, of each shim 53, 54, and the thickness, Dimension E, of frame 42 can be precisely controlled, each vertical gap, Dimension F, can also be precisely controlled. The thickness, Dimension D, of each shim can be controlled by precisely manufacturing a small portion of the snubber assembly 13. The thickness, Dimension E, of frame 42 can be precisely controlled during manufacture thereof. As with the horizontal gap, Dimension B, the distance between stage 41 and frame 42 defining each one of the vertical gaps, such as Dimension F, is controlled by precisely manufacturing the overall dimensions of stage assembly 10. The thickness, Dimension D, of shims 53, 54 only requires precision in the manufacturing of a comparatively small portion of snubber assembly 13, i.e., each shim 53, 54 itself. Again, it does not require that the position of each shim 53,54 be precisely determined during manufacturing of snubber assembly 13.

It is worthwhile to note that a vertical gap, Dimension G, is provided between mesas 51 and 52 to insure that they do not contact one another and thereby interfere with proper positioning of shims 53 and 54 (and consequently with the definition of the vertical gaps between stage 41 and snubber assembly 13, such as Dimension F). The size of the vertical gap, Dimension G, is not crucial.

For example, Dimension A can be approximately 300 microns, Dimension B can be approximately 10 microns, Dimension C can be approximately 310 microns, Dimension D can be approximately 25 microns, Dimension E can be approximately 300 microns, Dimension F can be approximately 10 microns, and Dimension G can be approximately 25 microns. However, as those skilled in the art will appreciate, various other values for these dimensions are likewise suitable and the dimensions used will depend upon the specific application.

Thus, only the mesas 51, 52, shims 53, 54 and stops 58, 59 of snubber assembly 13 need be precisely manufactured. These are comparatively small portions of snubber assembly 13 and can thus be precisely manufactured with relative ease. The overall dimensions of snubber assembly 13 do not require such precision. Moreover, according to one aspect of the present invention, close tolerances (Dimensions B and F, for example) between the stage 41 and the snubber assembly 13 are obtained without requiring that the larger dimensions of snubber assembly be precisely controlled.

Rather, the larger dimensions of stage assembly 10 are controlled, as well as the smaller dimensions of critical structures of snubber assembly 13 that cooperate with stage assembly 10 to determine the dimensions of critical gaps therebetween (such as Dimensions B and F). In this manner, the manufacturing process of the stage and snubber assembly of the present invention is simplified and the cost thereof is mitigated.

Optionally, channels 63 and 64 are formed in upper 11 and lower 12 portions of snubber assembly 13. Channels 63 and 64 mitigate the likelihood of edges 81 and 82 (FIG. 5) of stage 41 contacting upper 11 and lower 12 portions of snubber assembly 13 and causing damage to stage 41 and/or snubber assembly 13.

Similarly, cutouts 71-74 (best shown in FIG. 3) can be formed in upper 11 and lower 12 portions of snubber assembly 13 to inhibit corners 86-89 (FIG. 5) from contacting upper 11 and lower 12 portions of snubber assembly 13 and causing damage to stage 41 and/or snubber assembly 13.

In operation, stage 41 can move substantially in one translational degree of freedom, as indicated by arrow 16 of FIG. 1. For example, optics mounted to stage 41 can be moved in these directions to effect focusing and/or zooming of a camera. Such movement of stage 41 results in compression of one set of flexures (such as flexures 45 of FIG. 5), while simultaneously resulting in expansion of the other set of flexures (such as flexures 46 of FIG. 5). The amount of movement along this one degree of freedom is limited by the configuration of flexures 45, 46 and by the size of frame 42, not by snubber assembly 13.

It is also worthwhile to note that the stage and snubber assembly of the present invention can be configured such that during normal operation stage 41 does not contact snubber assembly 13. Thus, the snubbing action that can be provided by mesas 51, 52 and stops 58, 59 can be for extraordinary circumstances, such as when the device is accidentally dropped.

Movement in the five restricted degrees of freedom is comparatively limited. Translation of stage 41 from sided-to-side (toward and away from mesas 51, 52) is limited by mesas 51, 52. That is, when stage 41 moves from side-to-side by an amount greater than Dimension B, it contacts mesas 51, 52, which restrict its motion. Translation of stage 41 up and down (toward and away from stops 58, 59) is similarly limited by stops 58, 59. All rotations of stage 41 are limited by either mesas 51, 52 or stops 58, 59.

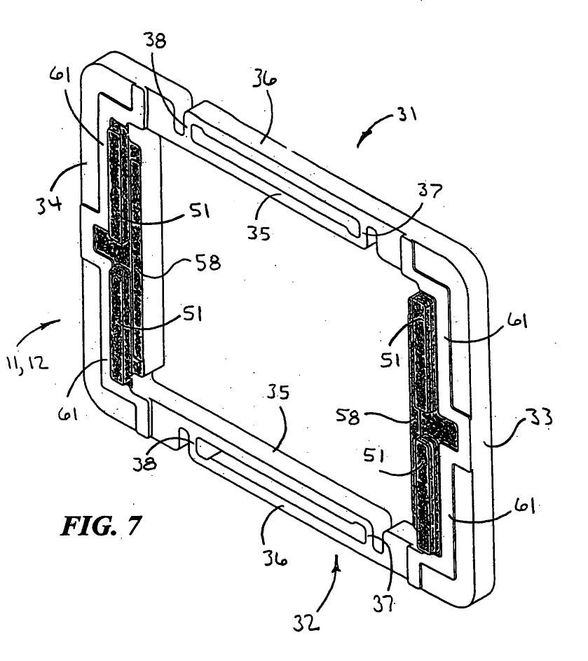

Referring now to FIGS. 7 and 8, those portions of stage assembly 10 and snubber assembly 13 where a viscous substance, such as oil, is disposed are indicated with stippling. Damping of the motion of stage 41 with respect to snubber assembly 13 (and consequently with respect to a camera or cellular telephone within which the stage and snubber assembly are disposed) can be effected by disposing oil intermediate stage 41 and snubber assembly 13. Thus, at least some of the oil that effects damping is disposed in the horizontal and vertical gaps between stage 41 and snubber assembly 13. The viscous substance forms a layer or a plurality of droplets that provide viscous resistance to movement of stage 41, so as to inhibit ringing and also so as to provide a cushion to shock and vibration through squeeze film damping.

Optionally, a void can be formed, such as by the cooperation of the mesas 51, 52 and frame 42, within which oil can be disposed, as shown in FIG. 8. The void can function as a reservoir, such that oil within the void can flow therefrom and into the horizontal and vertical gaps between stage 41 and the snubber assembly portions 11 and 12. Similarly, channels 63 and 64 can also provide oil to the horizontal and vertical gaps.

With particular reference to FIG. 8, mesas 51, 52 cooperate with stops 58, 59 to define a groove 110 of snubber assembly 13, within which a portion of stage 41 is received. Oil disposed within this groove functions to inhibit ringing and cushions stage 41.

Oil disposed in the horizontal and vertical gaps provides a cushion that tends to mitigate damage to stage 41, snubber assembly 13, and other components (such as camera optics) via both viscous resistance to movement and squeeze film damping. These effects can be beneficial in the event of excessive shock or vibration. Viscous resistance tends to inhibit movement of stage 41 along its normal direction of motion, as shown by arrow 16. Squeeze film damping tends to inhibit movement of stage 41 in the horizontal and vertical directions, as shown by the arrows in FIG. 8.

The amount of such cushion, particularly with respect to viscous resistance, is dependent upon the viscosity of the oil. More viscous oils tend to provide more viscous resistance, as well as more squeeze film damping.

At least at some viscosities, oil may not provide substantial shear resistance, and thus may not substantially inhibit movement of stage 41 along the directions of arrow 16. However, in the event of shock or vibration resulting in excessive movement of stage 41 to one extreme of the extent of its travel, the oil will inhibit subsequent rocking of stage 41 via squeeze film damping. In this manner, shock survivability of a camera incorporating the present invention is enhanced.

Referring now to FIGS. 9-12, ringing of stage 41, as well as damping of this ringing, is discussed. With particular reference to FIG. 9, the drive current signal for an actuator that moves stage 14 is shown. This curve also depicts the nominal desired displacement of the stage. That is, ideally, the stage would be at one position, as indicated by the leftmost, horizontal leg of the curve. Then, the stage would be driven, almost instantaneously to another position, as indicated by the middle, vertical leg of the curve. Subsequently, the stage would come to rest at its new position, as indicated by the rightmost leg of the curve. Such movement of stage 41 may be effected, for example, to focus and/or zoom a camera.

With particular reference to FIG. 10, an example of the resulting actual motion of stage 41, without damping, is shown. Ringing is evident on the rightmost, horizontal leg of this curve. This ringing results from back-and-forth oscillation of stage 41 that occurs when stage 41 abruptly stops at the end of its travel.

With particular reference to FIG. 11, damping substantially inhibits ringing. Ringing is inhibited due to the viscous resistance to motion along the directions of arrow 16 (FIG. 1) that damping provides. The amount of such damping depends upon the viscosity of the oil or other substance used.

With particular reference to FIG. 12, critical damping of the motion of stage 41 with respect to snubber assembly 13 is shown. As indicated by this curve, no ringing results. Rather, stage 41 settles gradually into its final position without oscillating back and forth.

In either instance (the instances being shown in FIGS. 11 and 12), the use of damping substantially reduces settling time. That is, an optics assembly is stable (not moving substantially) and ready for use sooner that it is when damping is not used (as shown in FIG. 10).

Whether damping results in a curve more like that of FIG. 11 or one more like that of FIG. 12 is dependent upon the viscosity of the viscous substance, e.g., oil. The viscosity of the viscous substance is dependent upon its physical properties and its temperature. The viscosity of the viscous substance can be selected such that at higher temperatures within the stage and snubber assembly's range of use reduced ringing like that of FIG. 11 is provided and at lower temperatures critical damping like that of FIG. 12 is provided.

One example of a suitable viscous substance is Clearco silicone oil, catalog number 63148-62-9, available from Clearco Products Co., Inc. of Bensalem, Pa. This oil comprises substantially pure dimethyl polysilonxane. Viscosities of between 200 cSt and 2,000 cSt are suitable. For example, viscosities of 350 cSt and 1,000 cSt are suitable. Lower viscosities tend to provide a curve more like FIG. 11, while higher viscosities tend to provide a curve more like FIG. 12.

Although oil, particularly silicone oil, is discussed herein as a suitable viscous substance for use in the present invention, those skilled in the art will appreciate that other viscous substances are similarly suitable. For example, grease may be used instead of oil. Indeed many different fluids may be suitable. Thus, the discussion of oil is by way of illustration only, and not by way of limitation.

Referring now to FIG. 8, a cellular telephone 180 comprises a camera 181, which can be substantially disposed therein. A lens or window 182 allows light to enter the camera.

Although the oil damped snubber assembly is described herein as being suitable for controlling the motion of a stage that supports the optics of a camera, those skilled in the art will appreciate that the stage can similarly be used to support other items. For example, the stage can alternatively be used to position a specimen for viewing under a microscope or to position the specimen for other types of analysis. Thus, discussing the invention herein as being useful for positioning the optics of a camera is by way of example only, and not by way of limitation.

Embodiments described above illustrate, but do not limit, the invention. It should also be understood that numerous modifications and variations are possible in accordance with the principles of the present invention. Accordingly, the scope of the invention is defined only by the following claims.

1. A system for controlling motion, the system comprising:
a stage;
a snubber; and
a viscous substance disposed intermediate the stage and the snubber so as to provide damping to movement of the stage.

2. A stage and snubber assembly for controlling motion, the stage and snubber assembly comprising:
a stage assembly;
a snubber assembly;
a viscous substance disposed intermediate the stage assembly and the snubber assembly to provide damping to movement of the stage; and
wherein the stage and snubber assembly are configured to move camera optics.

3. The stage and snubber assembly as recited in claim 2, wherein the viscous substance comprises oil.

4. The stage and snubber assembly as recited in claim 2, wherein the viscous substance comprises silicone oil.

5. The stage and snubber assembly as recited in claim 2, wherein the viscous substance comprises dimethyl polysiloxzane silicone.

6. The stage and snubber assembly as recited in claim 2, wherein the viscous substance has a viscosity that substantially mitigates ringing.

7. The stage and snubber assembly as recited in claim 2, wherein the viscous substance has a viscosity that that approximately effects critical damping.

8. The stage and snubber assembly as recited in claim 2, wherein the viscous substance has a viscosity of between approximately 200 cSt and approximately 2,000 cSt.

9. The stage and snubber assembly as recited in claim 2, wherein the viscous substance has a viscosity of approximately 350 cSt.

10. The stage and snubber assembly as recited in claim 2, wherein the viscous substance comprises silicone oil having a viscosity of between approximately 1,000 cSt.

11. The stage and snubber assembly as recited in claim 2, wherein:
the snubber assembly defines a groove;
a portion of the stage assembly is received within the groove; and
the viscous substance is dispose within the groove.

12. The stage and snubber assembly as recited in claim 2, wherein:
the snubber assembly comprises two portions that cooperate to define a groove;
a portion of the stage assembly is received within the groove; and
the viscous substance is dispose within the groove.

13. The stage and snubber assembly as recited in claim 2, wherein:
the snubber assembly comprises two opposed mesas and two opposed stops that cooperate to define a groove;
a portion of the stage assembly is received within the groove; and
the viscous substance is dispose within the groove.

14. The stage and snubber assembly as recited in claim 2, further comprising a reservoir from which the viscous substance can flow so as to be disposed intermediate the stage assembly and the snubber assembly.

15. The stage and snubber assembly as recited in claim 2, further comprising a void defined by two snubber portions and a frame of the stage assembly, the void defining a reservoir from which the viscous substance can flow so as to be disposed intermediate the stage assembly and the snubber assembly.

16. The stage and snubber assembly as recited in claim 2, further comprising a snubber portion having a channel formed therein, the channel defining a reservoir from which the viscous substance can flow so as to be disposed intermediate the stage assembly and the snubber assembly.

17. A camera comprising:
optics;
a stage assembly to which the optics are mounted;
a snubber assembly configured to limit motion of the stage; and
a viscous substance disposed intermediate the stage assembly and the snubber assembly to provide damping to movement of the stage.

18. A cell phone comprising a camera, the camera comprising:
optics;
a stage assembly to which the optics are mounted;
a snubber assembly configured to limit motion of the stage; and
a viscous substance disposed intermediate the stage assembly and the snubber assembly to provide damping to movement of the stage.

19. A stage and snubber assembly for controlling motion, the stage and snubber assembly comprising:
a stage assembly;
means for limiting motion of the stage assembly; and
means for damping movement of the stage disposed intermediate the stage assembly and the snubber assembly.

20. A method for controlling motion, the method comprising moving a stage with respect to a snubber, wherein a viscous substance is disposed intermediate the stage and the snubber so as to provide damping to movement of the stage.

21. A method for forming a stage and snubber assembly, the method comprising placing a viscous material between the stage and the snubber assembly so as to provide damping to movement of the stage.

22. A method for focusing a camera, the method comprising moving a focusing lens with respect to a snubber that limits movement of the focusing lens, wherein a viscous substance is disposed intermediate a stage to which the lens is attached and the snubber, so as to provide damping to movement of the lens.
